(19) United States
(12) Patent Application Publication
(10) Pub. No.: US 2022/0358366 A1
(43) Pub. Date: Nov. 10, 2022

(54) GENERATION AND IMPLEMENTATION OF DEDICATED FEATURE-BASED TECHNIQUES TO OPTIMIZE INFERENCE PERFORMANCE IN NEURAL NETWORKS

(71) Applicant: META PLATFORMS, INC., Menlo Park, CA (US)

(72) Inventors: Chihoon LEE, Sunnyvale, CA (US); Aosen WANG, Sunnyvale, CA (US)

(73) Assignee: META PLATFORMS, INC., Menlo Park, CA (US)

(21) Appl. No.: 17/307,844

(22) Filed: May 4, 2021

(51) Int. Cl. G06N 3/08; G06N 3/04

(52) U.S. Cl. CPC G06N 3/084; G06N 3/04

(57) ABSTRACT

According to examples, a system for implementing dedicated feature-based techniques to optimize inference performance in a neural network may include a processor and a memory storing instructions. The processor, when executing the instructions, may cause the system to determine enhanced relationship and interaction information associated with the first object and the second object and an initial feature value and generate a modified first embedding and a modified second embedding. The processor, when executing the instructions, may further cause the system to determine an updated feature value utilizing the modified first embedding and the modified second embedding and generate a prediction and a prediction loss associated with the first object and the second object utilizing the modified first embedding and the modified second embedding.

### TECHNICAL FIELD

This patent application relates generally to a neural network (NN) architecture, and more specifically, to systems and methods for implementing dedicated feature-based techniques to optimize inference performance in neural networks (NN).

### BACKGROUND

Neural networks (NN) have been usefully applied in a diverse variety of fields, including automatic speech and image recognition, natural language processing and bioinformatics. Neural networks (NN) have also been utilized in the field of social networks. One such way may be in content management and distribution, wherein neural networks (NN) may be utilized to recommend a content item to a user.

With more and more content being presented to users, content distributors are looking for new ways to effectively recommend and deliver content items that are of interest. In some instances, a neural network (NN) may be used to facilitate ranking of millions of content items according to numerous aspects in less than one second.

However, it should be appreciated that implementation of a neural network (NN) may often be computationally intense and costly. Accordingly, increasing efficiencies of neural networks may be highly desirable.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a diagram of an implementation structure for a network implementing deep learning, according to an example.

FIG. 2 illustrates a flow diagram of an implementation structure for a network implementing deep learning, according to an example.

FIG. 3 illustrates a flow diagram of an implementation structure for a network implementing deep learning, according to an example.

FIGS. 4A-C illustrate a flow diagram of an implementation structure for a network implementing deep learning, according to an example.

FIG. 5 illustrates a flow diagram of an implementation structure for a network implementing deep learning, according to an example.

FIG. 6A illustrates a block diagram of a system environment, including a system, that may be implemented to enable dedicated feature-based determinations for optimizing inference performance of neural networks, according to an example.

FIG. 6B illustrates a block diagram of a system environment, including a system, that may be implemented to enable feature-based determinations for optimizing inference performance of neural networks, according to an example.

FIG. 7 illustrates a block diagram of a computer system that may be implemented to enable feature-based determinations for optimizing inference performance of neural networks, according to an example.

FIG. 8 illustrates a flow diagram of a method for that may be implemented to enable feature-based determinations for optimizing inference performance of neural networks, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

With the proliferation of different types of digital content delivery mechanisms (e.g., mobile phone devices, tablet devices, etc.), content distributors may be continuously looking for new ways to deliver content of interest to users. To select a content item of interest, a content distributor may analyze and rank a library of content items based on various aspects. In these cases, as a number of aspects may increase, computational complexity may increase as well, often exponentially.

In some examples, to overcome these difficulties and effectively select a content item of interest, a content distributor may utilize a neural network (NN). In some examples, a neural network (NN) may include one or more computing devices configured to implement one or more networked machine-learning (ML) algorithms to “learn” by progressively extracting higher-level information from input data. In some examples, the one or more networked machine-learning (ML) algorithms of a neural network may implement “deep learning”. A neural network (NN) implementing deep learning may, in some examples, utilize one or more “layers” to dynamically transform input data into progressively more abstract and/or composite representations. These abstract and/or composite representations may be analyzed to determine hidden patterns and correlations and determine one or more relationships or association(s) within the input data. In addition, the one or more determined relationships or associations may be utilized to make predictions, such a likelihood that a user will be interested in a content item.

In some examples, the neural network may “learn” by utilizing a comparison of an actual output of the neural network to an output that the neural network was meant to produce. Learning may be supervised, semi-supervised or unsupervised. Supervised learning may include mapping an input to an output based on example input-output “pairs” in order to produce an inference function that may be used to map new scenarios. Semi-supervised learning may combine a small amount of labeled data with a large amount of unlabeled data to increase learning efficiencies. Unsupervised learning may learn patterns from untagged data by using self-organization techniques that may implement predilection determinations or probability densities analysis.

Examples of neural networks mechanisms that may be employed may include an artificial neural network (ANN), a sparse neural network (SNN), a convolutional neural network (CNN), and a recurrent neural network (RNN). Additional examples of neural network mechanisms that may be employed may also include a long/short term memory (LSTM), a gated repeated unit (GRU), a Hopfield network, a Boltzmann machine, a deep belief network and a generative adversarial network (GAN).

In addition to content item analysis and recommendation, neural networks may have a number of other applications as well. Exemplary applications may include image, audio and video recognition, recommendation systems, audio recognition (e.g., for virtual assistants) and autonomous driving. Additional examples may include machine vision, natural language processing, social networks and bioinformatics. Indeed, neural networks may be applied in any context that may require highly efficient computations for analysis of numerous (e.g., millions) items according to various aspects in a short period of time.

However, it should be appreciated that as a number of structural elements (e.g., layers, nodes, etc.) associated with the neural network may need to be increased, additional computation time and network resources may be required to generate an output. Accordingly, increasing efficiencies of neural networks may be highly desirable.

Systems and methods to enhance inference performance of a neural network (NN) are described. In some examples, to enhance the inference performance of the neural network (NN), the systems and methods may incorporate generation and implementation of a difference from a ground truth (or true labels), or “auxiliary loss”. As will be discussed below, in some examples, the auxiliary loss may be generated to capture representative feature-based information that may provide enhanced representations of relationships and interactions between a first object and a second object. As will also be discussed below, in some examples, the auxiliary loss may be used to enhance accuracy of predictions associated with the first object and the second object.

In some examples, the described systems and methods may utilize an observed feature that may be related to one or more first objects (e.g., users) and one or more second objects (e.g., content items) in order to predict an association between a user and a content item. So, in one example, the (observed) feature may be a number of clicks on similar content items, and the prediction may be a “click estimation” that may indicate a likelihood that the particular user may click on the particular content item. Such likelihoods may be calculated for each content item in the library of content items and determine which content item in the library of content items may be most likely to be selected by the particular user.

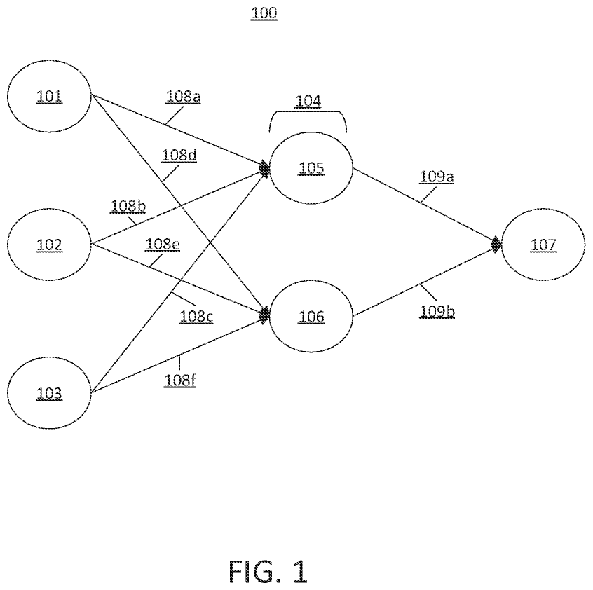

FIG. 1 illustrates a diagram of an implementation structure for a neural network (NN) 100 (hereinafter also referred to as “network 100”) implementing deep learning, according to an example. In some examples, implementation of the network 100 may include organizing a structure of the neural network 100 and “training” the neural network 100.

In some examples, organizing the structure of the neural network 100 may include network elements including one or more inputs, one or more nodes and an output. In some examples, a structure of the network 100 may be defined to include a plurality of inputs 101, 102, 103, a layer 104 with a plurality of nodes 105, 106, and an output 107. In addition, in some examples, organizing the structure of the network 100 may include assigning one or more weights associated with the plurality of nodes 105, 106. In some examples, the network 100 may implement a first group of weights 108, including a first weight 108a between the input 101 and the node 105, a second weight 108b between the input 102 and the node 105, a third weight 108c between the input 103 and the node 105. In addition, the network 100 may implement a fourth weight 108d between the input 101 and the node 106, a fifth weight 108e between the input 102 and the node 106, and a sixth weight 108f between the input 103 and the node 106 as well. In addition, a second group of weights 109, including the first weight 109a between the node 105 and the output 107 and the second weight 109b between the node 106 and the output 107 may be implemented as well.

In some examples, “training” the network 100 may include utilization of one or more “training datasets” {(xᵢ, yᵢ)}, where i=1 . . . N for an N number of data pairs. In particular, as will be discussed below, the one or more training datasets {(xᵢ, yᵢ)} may be used to adjust weight values associated with the network 100.

Training of the network 100 may also include, in some examples, may also include implementation of forward propagation and backpropagation. Implementation of forward propagation and backpropagation may include enabling the network 100 to adjust aspects, such as weight values associated with nodes, by looking to past iterations and outputs. In some examples, a forward “sweep” through the network 100 to compute an output for each layer. At this point, in some examples, a difference (i.e., a “loss”) between an output of a final layer and a desired output may be “back-propagated” through previous layers by adjusting weight values associated with the nodes in order to minimize a difference between an estimated output from the network 100 (i.e., an “estimated output”) and an output the network 100 was meant to produce (i.e., a “ground truth”). In some examples, training of the network 100 may require numerous iterations, as the weights may be continually adjusted to minimize a difference between estimated output and an output the network 100 was meant to produce.

In some examples, once weights for the network 100 may be learned, the network 100 may be used make an “inference” and determine a prediction loss. In some examples, the network 100 may make an “inference” for a data instance, x*, which may not have been included in the training datasets {(xᵢ, yᵢ)}, to provide an output value y* (i.e., an inference) associated with the data instance x*. Furthermore, in some examples, a prediction loss indicating a predictive quality (i.e., accuracy) of the network 100 may be ascertained by determining a “loss” representing a difference between the estimated output value y* and an associated ground truth value.

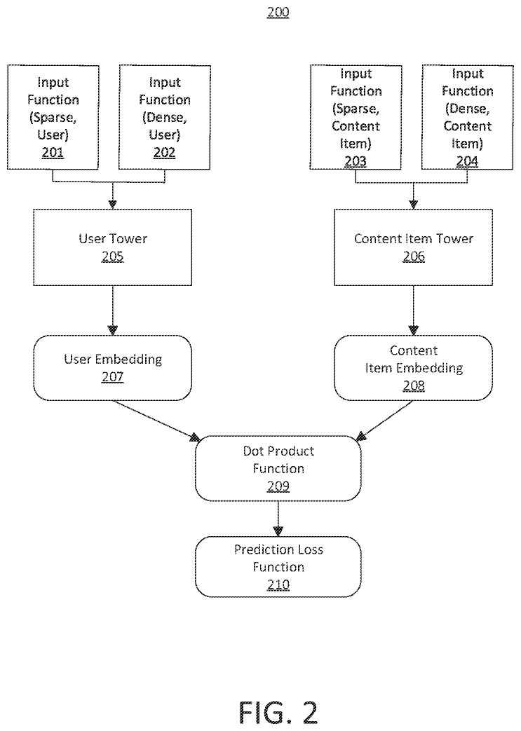

FIG. 2 illustrates a flow diagram of an implementation structure for a neural network (NN) 200 (also referred to as the “network 200”) implementing deep learning, according to an example. In some instances, the network 200 may be referred to as a “two-tower” neural network (TTSN). In this example, the first object may be a user and a second object may be a content item, wherein the network 200 may be implemented to aid in recommendation of the content item for the user. However, it should be appreciated that the network 200 may be applied other contexts as well, such as machine vision, natural language processing, social networks and bioinformatics.

Initially, in some examples, input functions 201-204 of the network 200 may be used to gather feature information associated with a user and a content item. In some examples, the gathered feature information may include one or more of sparse features associated with the user, dense features associated with the user, sparse features associated with the content item and dense features associated with the content item. Sparse features may include data representations (e.g., vectors) that may have a large percentage of zero values and may be easily compressed. Dense features may include data representations that include a lesser percentage of zero values, and may be more difficult to compress. As discussed below, the gathered feature information associated with the user and the content item may be used to analyze relationships and interactions between the user and the content item.

In this example, the network 200 may implement a first multi-layer neural network (NN) tower 205 associated with a user (a “user tower”) and a second multi-layer neural network (NN) tower 206 associated with a content item (a “content item tower”). In some examples, the user tower 205 and content item tower 206 may be implemented to utilize one or more layers to analyze the gathered feature information and to determine one or more relationships and interactions between the user and the content item. As used herein, a “relationship” may include any definable association between a first object and a second object, and “interaction” may include any dependency or interrelation that a first object and a second object may have.

In some examples, the first multi-layer neural network (NN) tower 205 associated with a user may be used to generate a first embedding 207 associated with the user (the “user embedding”), and the second multi-layer neural network (NN) tower 206 associated with a content item may be used to generate a second embedding 208 relating to a content item (the “content item embedding”). In some examples, the user embedding 207 and the content item embedding 208 may utilized to provide embedding-level feature information that may capture one or more relationships and interactions associated with the user and the content item.

Also, in some examples, to generate a prediction for a first object and a second object, the network 200 may utilize a dot product function 209. In particular, in some examples, the dot product function 209 may be used to estimate a dot product of the user embedding 207 and the content item embedding 208, which may indicate (i.e., predict) an association between the user and the content item. In one example, the dot product of the user embedding 207 and the content item embedding 208 may indicate a likelihood that a user may select a content item.

In addition, the network 200 may also utilize a prediction loss function 210 to determine a prediction loss, which may indicate how accurately the network 200 may predict an association between the content item and the user. In some examples, to determine the prediction loss, the prediction loss function 210 may calculate a difference between an estimated dot product and a ground truth value.

So, in some examples, the network 200 may utilize gathered feature information associated with a user and a content item to generate a dot product and a prediction loss. However in some examples, while the analysis of the gathered feature information may be effective for these determinations, the analysis may not always sufficiently capture “enhanced” (i.e., detailed) relationship and interaction information that may be available. This may be unfortunate, as the enhanced relationship and interaction information may be used to more accurately determine user interests and enhance (e.g., personalize) content item recommendations for users. As used herein, the “enhanced relationship and interaction information” may include any and all relationship and interaction information that may be derived from a dedicated empirical-driven analysis.

In some examples, aspects of the network 200 may be modified to overcome these deficiencies of the network 200. In some examples, to capture the enhanced relationship and interaction information that may be available from the feature information associated with the first object and the second object, an additional “feature tower” may be added (not shown). However, while the addition of the feature tower may provide access to the enhanced relationship and interaction information, it should also be appreciated that the feature tower may result in a significant increase in expenditure of network resources and computation budget(s), and may limit applicability of the network 200 in many contexts.

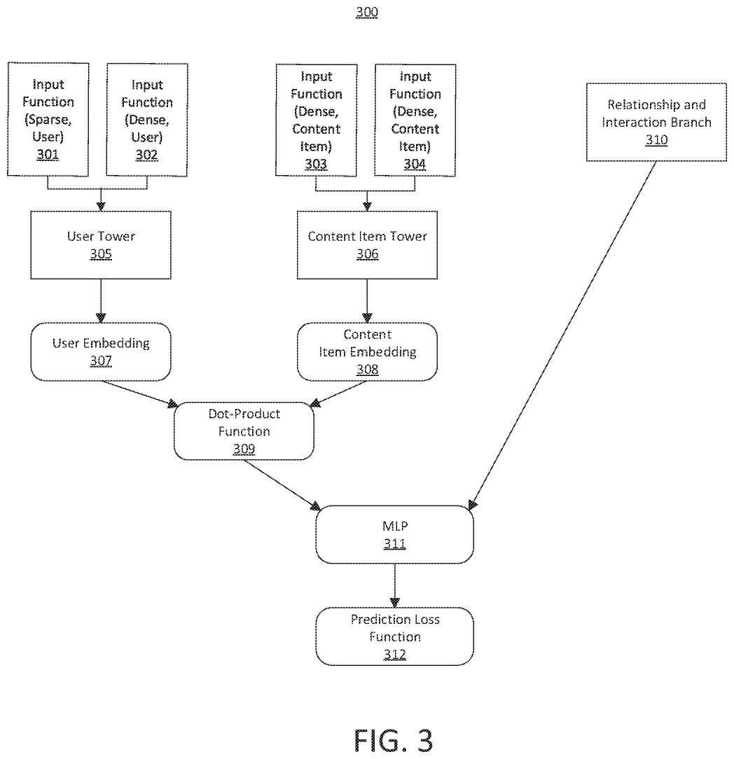

FIG. 3 illustrates a flow diagram of an implementation structure for a network 300 implementing deep learning, according to an example. In some examples, the network 300 may employ a two-tower neural network (TTSN), similar to the network 200 as illustrated in FIG. 2. Also, in some examples, the network 300 may aid in selection of a content item for a user. However, it should be appreciated that the network 300 may be applied other contexts as well, such as drug discovery and toxicology, visual information processing and financial fraud detection.

So, in some examples, the network 300 may utilize input functions 301-304 to gather feature information (e.g., sparse features, dense features) related to a user and a content item, and may implement a user tower 305 and a content item tower 306 to analyze the gathered feature information. In particular, the network 300 may generate a user embedding 307 and a content item embedding 308 and may determine utilize a dot-product function 309 to determine a dot-product of the user embedding 307 and the content item embedding 308 to indicate an association between the user and the content item.

In some examples, the network 300 may also include a “relationship and interaction” branch 310. The relationship and interaction branch 310 may analyze gathered feature information to generate interaction and relationship information that may be associated with the user and the content item. In some examples, the generated interaction and relationship information may be utilized to generate more accurate predictions of associations between the user and the content item (e.g., a selection likelihood).

In some examples, the network 300 may utilize a multi-layer perceptron (MLP) 311 to analyze a dot product generated via the dot-product function 309, and relationship and interaction information generated via the interaction branch 310. More particularly, in some examples, the multi-layer perceptron (MLP) 311 may “merge” the inputted dot-product and the inputted relationship and interaction information to generate an auxiliary loss to indicate an association between a user and a content item. In addition, the generated feature metric and a ground truth may be used by a prediction loss function 312 to determine a prediction loss. In some examples, the prediction loss may be used to indicate how accurately the network 300 may predict an association between the content item and the user.

Accordingly, in some examples, addition of a relationship and interaction branch (e.g., the interaction branch 310) may offer the benefit of incorporating relationship and interaction information resulting from a dedicated analysis to generate a prediction associated with a user and a content item. However, it should also be appreciated that, in some examples, this may result in a significant increase in expenditure of network resources and computation budget(s). In particular, in some examples, this may require implementation of the multi-layer perceptron (MLP) 311, which may result in an significant increase in a computation budget and latency for the network 300. Moreover, in some examples, this may require dedicated and extensive preparation and processing of the gathered feature information as well.

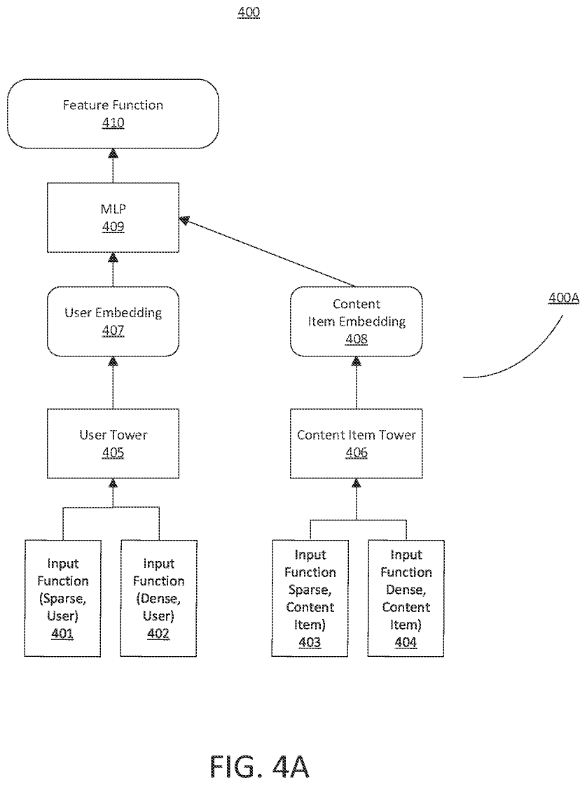

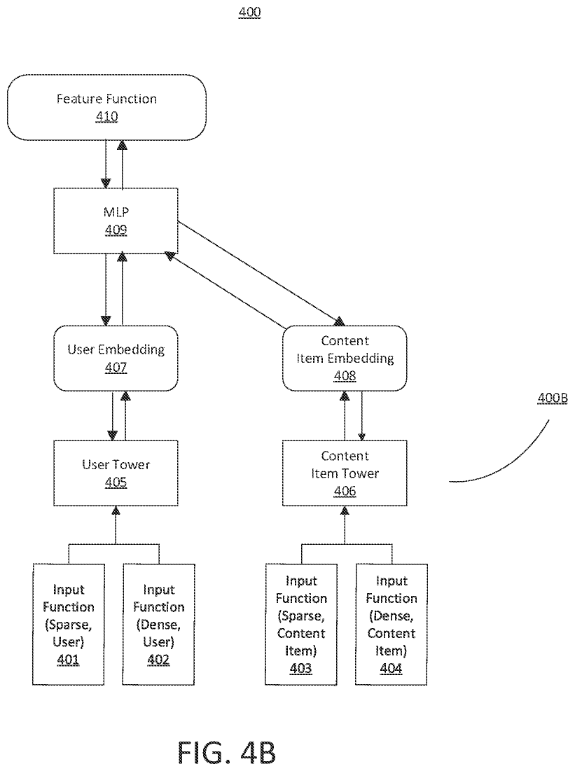

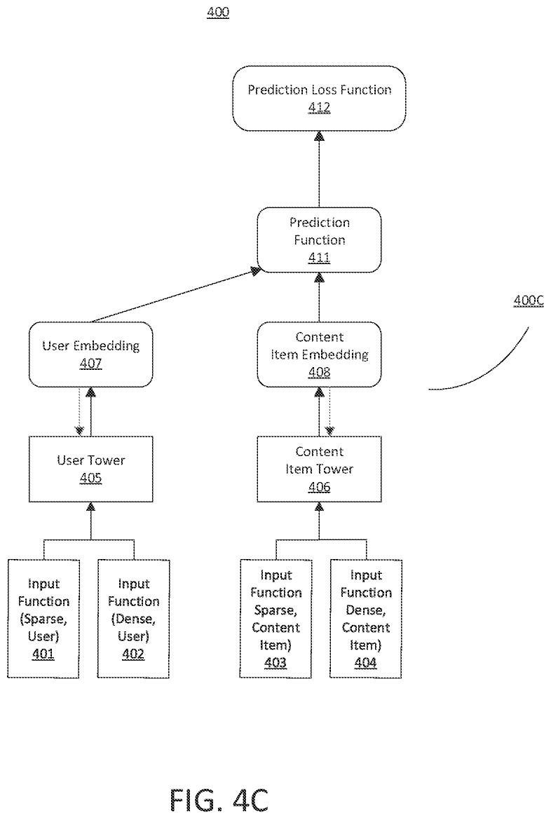

FIGS. 4A-C illustrates a flow diagram of an implementation structure for a neural network 400 (also “network 400”) implementing deep learning, according to an example. In some examples, implementation of the network 400 may include a plurality of stages, including generating a network structure for network 400, implementing a training stage for the network 400, and implementing an inference stage for the network 400.

In addition, in some examples, similar to the network 300 illustrated in FIG. 3, the network 400 may include a two-tower structure directed to a first object and a second object. In one example, the first object may be a user and the second object may be a content item, wherein the network 400 may be utilized to recommend a content item to a user. However, it should be appreciated that the network 400 may be applied in other contexts as well, such as customer relationship management (CRM), automatic speech recognition, and military activities and operations. So, in an example involving e-commerce, a first object may be a user visiting an e-commerce site and a second object may be an item to be sold. In an example involving recommendations (e.g., movies, music, etc.), a first object may be a user using the recommendation service and the second object may be a movie or music item. Also, in an example involving autonomous driving, the first object may be a present road status or road object (e.g., traffic signals, pedestrians, etc.), while a second object may be an action to be taken by a vehicle (e.g., stop, go, etc.). As used herein, a “vehicle” may include any machine that may transport a user or an item (i.e., cargo).

As discussed below, in some examples, the network 400 may provide enhanced analysis of object features during an inference stage without requiring additional computations and costs. Moreover, as also discussed below, in some examples, enhanced relationship and interaction information may be generated during a training stage and may be implicitly captured for utilization during the inference stage in order to generate predictions of greater accuracy.

Turning now to FIG. 4A, in some examples, generation of a network structure for the network 400 may include implementing input functions 401-404 to gather feature information (e.g., sparse and dense features) from input data associated with a user and a content item respectively. In addition, it may also include implementing a user tower 405 tower and a content item tower 406 to utilize the input functions 401-404 to generate a user embedding 407 and a content item embedding 408. In some examples, as discussed below, the user embedding 407 and the content item embedding 408 may be utilized to provide embedding-level feature information associated with the user and the content item.

Upon generating a structure of the network 400, a forward propagation phase of a training stage 400A for the network 400 may be implemented. In particular, in some examples, embedding-level feature information provided by the user embedding 407 and the content item embedding 408 may be provided to a multi-layer perceptron (MLP) 409 to generate a feature value. In some examples, the generated feature value may capture enhanced relationship and interaction information associated with the user and the content item from the provided embedding-level feature information. In addition, a feature function 410 may also be implemented to determine an initial auxiliary loss, which may be utilized to implicitly transmit the enhanced relationship and interaction information to the network 400 during the training stage of the network 400. In some examples, the initial auxiliary loss may be determined by a difference between the (initial) feature value and a ground truth value.

Turning now to FIG. 4B, in some examples, upon determining an initial auxiliary loss, a backpropagation phase of a training stage 400B for the network 400 may be implemented. That is, in some examples, the initial auxiliary loss may be “backpropagated” (i.e., returned) to enable (re)generation of the user embedding 407 and the content item embedding 408. It should be appreciated that training of the network 400 during the backpropagation phase of the training stage 400B may include, in some examples, utilization of one or more machine-learning techniques.

In some examples, the (re)generated user embedding 407 may be referred to as an “modified” user embedding and the (re)generated content item embedding 408 may be referred to as an “modified” content item embedding. So, in some examples, the (re)generated user embedding 407 and a content item embedding 408 may be provided to the multi-layer perceptron (MLP) 409 to determine an updated feature value. In addition, as discussed below, the feature function 410 may also be implemented to determine an updated auxiliary loss, which may be used to optimize the network according to the available feature information associated with the user and the content item. Moreover, in some examples, this “back-and-forth” process may be repeated until the network 400 may be optimized for auxiliary loss. Accordingly, in some examples, since the updated auxiliary loss may implicitly capture and transmit enhanced relationship and interaction information associated with the user and the content item via the user embedding 407 and the content item embedding 408, this may result in more effective representation of feature related information associated with the user and the content item and more accurate predictions. Moreover, in some examples, the enhanced relationship and interaction information may be utilized to enhance and further personalize content item recommendations (i.e., predictions) for the user by the network 400 during an inference stage.

Turning now to FIG. 4C, in some examples, upon optimizing the network 400 with respect to auxiliary loss, enhanced relationship and interaction information implicitly captured during an inference stage 400C of the network 400 may be utilized to generate a prediction associated with a user and a content item. In some examples, to generate a prediction for a first object and a second object, the network 400 may utilize a prediction function 411. In particular, in some examples, the prediction function 411 may be used to calculate a dot product of the user embedding 407 and the content item embedding 408. In one example, the calculated dot product may indicate a likelihood that a user may select a content item, and may be utilized to improve performance in click-through rate (CTR) predictions and recommendations. In some examples, a click-through-rate (CTR) may be a ratio indicating a likelihood (i.e., prediction) that a user will engage a piece of content item to a number of total users who will engage the content item.

It should be appreciated that upon optimizing the network 400 with respect to auxiliary loss, a calculation of a dot product associated with the user and the content item may incorporate enhanced relationship and interaction information implicitly captured during the training stage of network 400. Moreover, the incorporated enhanced relationship and interaction information implicitly captured via the user embedding 407 and the content item embedding 408 may be utilized to generate more accurate predictions.

In addition, the network 400 may also utilize a prediction loss function 412 to determine a prediction loss. In some examples, the prediction loss may quantify how accurately the network 400 may predict an association between the content item and the user. In some examples, the prediction loss function 412 may calculate the prediction loss for the network 400 by determining a difference between a dot product generated by the prediction function 411 and a ground truth value.

Accordingly, by limiting a determination of auxiliary loss to the training stage of the network 400 and decoupling the auxiliary loss determination from the inference stage of the network 400, utilization of computing resources during an inference stage of the network may be enhanced. In particular, predictions generated during an inference stage of the network 400 may be imbued with the benefit of enhanced relationship and interaction information captured during the training stage via the (trained) user embedding 407 and the (trained) content item embedding 408, and therefore result in more accurate predictions.

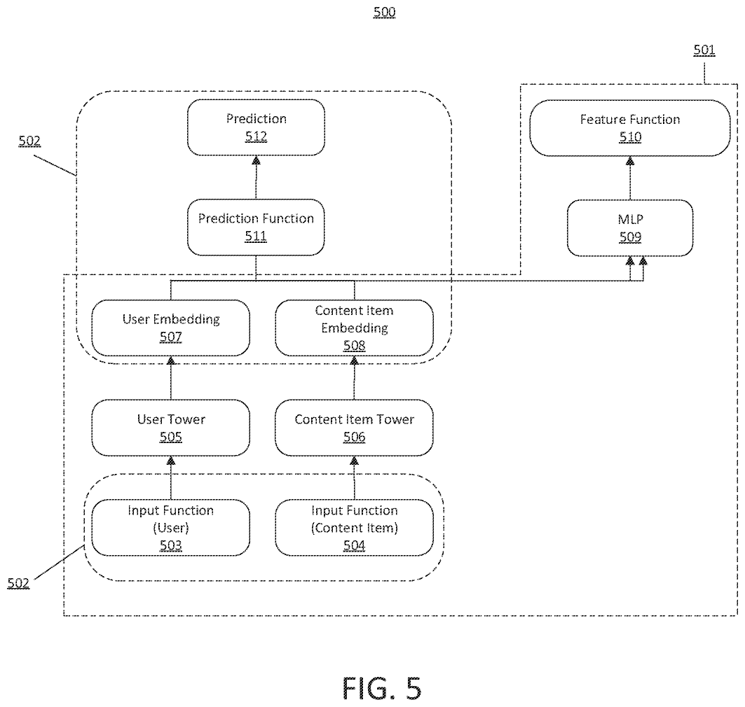

FIG. 5 illustrates a flow diagram of an implementation structure for a neural network 500 (also “network 500”) implementing deep learning, according to an example. In some examples, network elements 501 may be implemented and/or utilized during a training stage, while network elements 502 may be implemented during an inference stage. That is, in some examples, during the inference stage the network elements 501 may remain offline and may not be necessary to generate a prediction during an inference stage.

In one example, the first object may be a user and the second object may be a content item, wherein the network 500 may be utilized to recommend a content item to a user. However, it should be appreciated that the network 500 may be applied in other contexts as well, such as customer relationship management (CRM), automatic speech recognition, and military activities and operations.

So, in some examples, the network elements 501 that implement a training stage of the network 500 may include the input function 503 and input function 504, which may be utilized to gather feature information relating to the user and the content item respectively. Also, similar to the network 400 shown in FIG. 4, a user tower 505 and a content item tower 506 may be used to generate a user embedding 507 and a content item embedding 508. In one example, the user tower 505 and the content item 506 may implement a type of multi-layer perceptron (MLP) to generate the user embedding 507 and the content item embedding 508. It should be appreciated that, in other examples, other neural network mechanisms besides a multi-layer perceptron (MLP) may be utilized as well.

In addition, in some examples, the user embedding 507 and the content item embedding 508 may be provided to a multi-layer perceptron (MLP) 509 to analyze embedding-level information and determine enhanced relationship and interaction information. More particularly, in some examples, the training stage for the network 500 may implement forward propagation and backpropagation to generate and update an auxiliary loss.

In some examples, once the network 500 may be optimized for feature analysis (i.e., the training of the network 500 may be complete), an inference stage may be implemented to generate a prediction associated with a user and a content item. So, in some examples, the network elements 502 that implement the inference stage of the network 500 may include the input function 503 directed to user inputs, the input function 504 directed to content item inputs, the user embedding 507 and content item embedding 508. In particular, the user embedding 507 and content item embedding 508, imbued with the enhanced relationship and interaction information generated during the training stage may be utilized by the prediction function 511 to generate the prediction 512.

In some examples, during an inference stage the network elements user tower 505, the content item tower 506, the multi-layer perceptron (MLP) 509 and the feature function 510 may remain offline. Accordingly, as predictions generated during an inference stage of the network 500 may only require fetching of inputs via the input function 503 and the input function 504 and previously trained embeddings (e.g., the user embedding 507 and content item embedding 508), a need for additional computing resources (e.g., the MLP 509) and time for feature analysis during the inference stage may be negated.

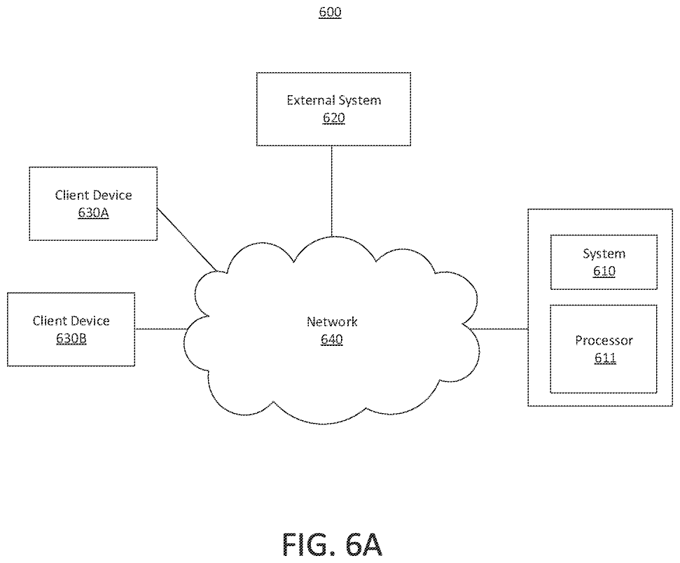

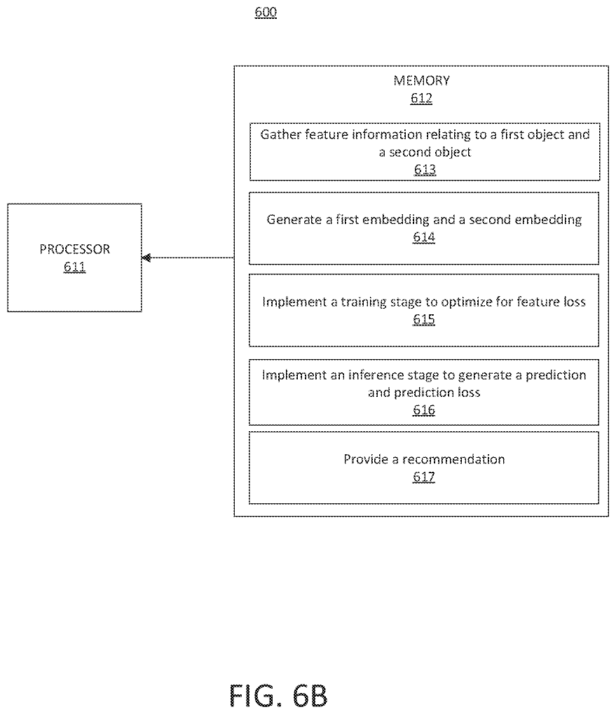

Reference is now made to FIGS. 6A-B. FIG. 6A illustrates a block diagram of a system environment, including a system, that may be implemented to enable auxiliary loss determinations for optimizing inference performance of neural networks, according to an example. FIG. 6B illustrates a block diagram of a system environment, including a system, that may be implemented to enable auxiliary loss determinations for optimizing inference performance of neural networks, according to an example. As will be described in the examples below, one or more of system 610, external system 620, client devices 630A-B and system environment 600 shown in FIGS. 6A-B may be operated by a service provider to implement a neural network (NN) architecture to generate and optimize more effective feature-related learnings from neural network embeddings and predict associations between a first object and a second object.

It should be appreciated that one or more of the system 610, the external system 620, the client devices 630A-B and the system environment 600 depicted in FIGS. 6A-B may be provided as examples. Thus, one or more of the system 610, the external system 620 the client devices 630A-B and the system environment 600 may or may not include additional features and some of the features described herein may be removed and/or modified without departing from the scopes of the system 610, the external system 620, the client devices 630A-B and the system environment 600 outlined herein. Moreover, in some examples, the system 610, the external system 620, and/or the client devices 630A-B may be or associated with a social networking system, a content sharing network, an advertisement system, an online system, and/or any other system that facilitates any variety of digital content in personal, social, commercial, financial, and/or enterprise environments. In other examples, the system 610, the external system 620, and/or the client devices 630A-B may be utilized in image, audio and video recognition, recommendation systems, audio recognition (e.g., for virtual assistants), autonomous driving natural language processing, social networks and bioinformatics.

While the servers, systems, subsystems, and/or other computing devices shown in FIGS. 6A-B may be shown as single components or elements, it should be appreciated that one of ordinary skill in the art would recognize that these single components or elements may represent multiple components or elements, and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the system 610, the external system 620, the client devices 630A-B or the system environment 600.

It should also be appreciated that the systems and methods described herein may be particularly suited for digital content, but are also applicable to a host of other distributed content or media. These may include, for example, content or media associated with data management platforms, search or recommendation engines, social media, and/or data communications involving communication of potentially personal, private, or sensitive data or information. These and other benefits will be apparent in the descriptions provided herein.

In some examples, the external system 620 may include any number of servers, hosts, systems, and/or databases that store data to be accessed by the system 610, the client devices 630A-B, and/or other network elements (not shown) in the system environment 600. In addition, in one example, the servers, hosts, systems, and/or databases of the external system 620 may include one or more storage mediums storing any data. So in one example, and as will be discussed further below, the external system 620 may be utilized by a service provider distributing content (e.g., a social media application provider) to store any information relating to one or more users of content items and a library of one or more content items (e.g., advertisements).

In some examples, and as will be described in further detail below, the client devices 630A-B may enable a client (e.g., a user) to view content from a service provider distributing content (e.g., a social media application provider). In one example, the client devices 630A-B may be electronic or computing devices configured to transmit and/or receive data. In this regard, each of the client devices 630A-B may be any device having computer functionality, such as a television, a radio, a smartphone, a tablet, a laptop, a watch, a desktop, a server, or other computing or entertainment device or appliance. In one example, the client device 630A may be utilized by a first user viewing content (e.g., advertisements) distributed by a service provider (e.g., a social media application provider). In one example, the client device 630B may be utilized by a second user to provide feedback (e.g., likes, comments) that may be utilized to generate feature-related information for a content item distributed by the service provider. In some examples, user-related information may be stored and transmitted by the client devices 630A-B to other devices, such as the external system 620.

The system environment 600 may also include network 640. In operation, one or more of the system 610, the external system 620 and the client devices 630A-B may communicate with one or more of the other devices via the network 640. The network 640 may be a local area network (LAN), a wide area network (WAN), the Internet, a cellular network, a cable network, a satellite network, or other network that facilitates communication between, the system 610, the external system 620, the client devices 630A-B and/or any other system, component, or device connected to the network 640.

The network 640 may further include one, or any number, of the exemplary types of networks mentioned above operating as a stand-alone network or in cooperation with each other. For example, the network 640 may utilize one or more protocols of one or more clients or servers to which they are communicatively coupled. The network 640 may facilitate transmission of data according to a transmission protocol of any of the devices and/or systems in the network 640. Although the network 640 is depicted as a single network in the system environment 600 of FIG. 6A, it should be appreciated that, in some examples, the network 640 may include a plurality of interconnected networks as well. In some examples, as will be discussed below, the client devices 630A-B may be mobile devices that are communicatively coupled to network 640 and enabled to interact with various network elements over the network 640. In some examples, the client devices 630A-B may execute an application (e.g., a social media application) allowing a user of the client devices 630A-B to interact with various network elements on the network 640.

In some examples, the system 610 may be implemented in association with neural network (NN) architecture to enable auxiliary loss determinations for optimizing inference performance of neural networks. In some examples, the system 610 may also be configured to analyze embedding-level information, determine enhanced relationship and interaction information for a first object and a second object during an inference stage and determine an optimized auxiliary loss during a training stage. Furthermore, in some examples, the system 610 may utilize the enhanced relationship and interaction information implicitly captured during the training stage to generate predictions during an inference stage that may be more accurate. Details of the system 610 and its operation within the system environment 600 will be described in more detail below.

As shown in FIGS. 6A-B, the system 610 may include processor 611 and the memory 612. In one example, the processor 611 may be configured to execute the machine-readable instructions stored in the memory 612. It should be appreciated that the processor 611 may be a semiconductor-based microprocessor, a central processing unit (CPU), an application specific integrated circuit (ASIC), a field-programmable gate array (FPGA), and/or other suitable hardware device.

In one example, the memory 612 may have stored thereon machine-readable instructions (which may also be termed computer-readable instructions) that the processor 611 may execute. The memory 612 may be an electronic, magnetic, optical, or other physical storage device that contains or stores executable instructions. The memory 612 may be, for example, Random Access memory (RAM), an Electrically Erasable Programmable Read-Only Memory (EEPROM), a storage device, an optical disc, or the like. The memory 612, which may also be referred to as a computer-readable storage medium, may be a non-transitory machine-readable storage medium, where the term “non-transitory” does not encompass transitory propagating signals. It should be appreciated that the memory 612 depicted in FIG. 6B may be provided as an example. Thus, the memory 612 may or may not include additional features, and some of the features described herein may be removed and/or modified without departing from the scope of the memory 612 outlined herein.

It should be appreciated that the processing performed via the instructions on the memory 612 may or may not be performed, in part or in total, with the aid of other information and data, such as information and data provided by the external system 620 and/or the client devices 630A-B. Moreover, and as described further below, it should be appreciated that the processing performed via the instructions on the memory 612 may or may not be performed, in part or in total, with the aid of or in addition to processing provided by other devices, including for example, the external system 620 and/or the client devices 630A-B.

Although not depicted, it should be appreciated that instructions on the memory 612 may also be configured to utilize various artificial intelligence (AI) based machine learning tools. For instance, these AI-based machine learning tools may be used to generate models that may include a neural network (NN), a generative adversarial network (GAN), a tree-based model, a Bayesian network, a support vector, clustering, a kernel method, a spline, a knowledge graph, or an ensemble of one or more of these and other techniques. It should also be appreciated that the system 610 may also be configured to utilize other types of machine learning approaches as well, such as reinforcement learning, feature learning, anomaly detection, etc.

The memory 612 may store instructions, which when executed by the processor 611, may cause the processor to: gather 613 feature information relating to a first object and a second object; generate 614 a first embedding and a second embedding; implement 615 a training stage to optimize a neural network for auxiliary loss; implement 616 an inference stage of the neural network to generate a prediction and a prediction loss; and provide 617 a recommendation. In some examples, the instructions 613-617 may be utilized to enable a neural network to recommend a content item (i.e., a first object) to a user (i.e., a second object). However, as discussed above, it should be also appreciated that the system 610 may also be utilized to optimize neural network applications for image, audio and video recognition, recommendation systems, audio recognition (e.g., for virtual assistants), autonomous driving natural language processing, social networks and bioinformatics.

As shown in FIG. 6B, in some examples, the instructions 613 may be utilized to implement a first input function to gather feature information associated with a user (i.e., a first object) and a content item (i.e., a second object). In some examples, the instructions 613 may be utilized to recommend the content item to the user. In some examples, the gathered feature information may include one or more of sparse features associated with the user, dense features associated with the user, sparse features associated with the content item and dense features associated with the content item.

In some examples, the instructions 614 may be implemented in association with a neural network (NN) to generate a user embedding and a content item embedding. In this example, to generate the user embedding and the content item embedding, the neural network (NN) may analyze gathered feature information relating to the user and the content item.

In some examples, the instructions 615 may implement a training stage including forward propagation to optimize a neural network for auxiliary loss. That is, in some examples, the instructions 615 may provide the embedding-level feature information from a user embedding and a content item embedding (e.g., via the instructions 614) to a multi-layer perceptron (MLP) to generate a feature value. In some examples, the feature value may capture enhanced relationship and interaction information associated with the user and the content item. In addition, in some examples, the instructions 615 may also implement a feature function to determine an initial auxiliary loss, which may be used to implicitly transmit the enhanced relationship and interaction information during an inference stage of the network. In some examples, the generation of the initial feature value and the initial auxiliary loss may be part of a forward propagation phase of the training stage for the network.

In some examples, to generate an auxiliary loss, a function Loss(D) may be utilized for a data set D={(xᵢ, yᵢ)}, where i=1 . . . N. In some examples, the feature function Loss(D) may be defined as follows:

$$Loss ( D ) = \frac{1}{N} * {\sum }_{i = 1}^{N} f ( {y}_{i} , {\hat{y}}_{i} )$$

In this example, ƒ(a, b) may be defined a p norm of normed vector space.

In some examples, the following equation may express a scalar difference between a first input vector and a second input vector in absolute value:

$${‖ z ‖}_{p} = {( {\sum }_{j = 1}^{d} {\vert {z}_{i} \vert}^{p} )}^{1 / p}$$

In these examples, z may a function to measure the difference between two vectors of a and b. In one example, the values of d, p, and z may be d=1, p=1, and z=(a−b).

Moreover, it should be appreciated that these loss function determinations may be modified to a particular application setting. In one example, where the loss function may be applied to a recommendation and ranking system for users and content items, a value of d may be 1 and a value of p may be 2. That is, given loss function f (u, v), the values of d and z may p=2, z=(u−v), where u and v may be a d dimensional vector. Also, in this example, when d=1, u may be a scalar value and v may be a scalar value. Furthermore, in this instance, the loss function f (u, v)=(z_1)^{1/2}, where z_1=(u−v)².

In another example, applied to an image-based application (e.g., autonomous driving), the following equation may be utilized:

$${‖ z ‖}_{2} = {( {\sum }_{j = 1}^{d} {z}_{j}^{2} )}^{1 / 2}$$

In one such example, a selected value of d may be a number of pixels in a given image and a selected value of p may be 2.

In some examples, to implement the training stage, the instructions 615 may implement a backpropagation phase of a training stage. In some examples, the instructions may enable the initial auxiliary loss to be “backpropagated” (i.e., returned) to enable (re)generation of a user embedding and a content item embedding, thereby resulting in more effective representation of feature-related information associated with the user and the content item and more accurate predictions during an inference stage. Also, in some examples, to backpropagate the initial auxiliary loss, the (re)generated user embedding and the (re)generated content item embedding may be provided to the multi-layer perceptron (MLP), such as the MLP 409 illustrated in FIG. 4, to determine an updated feature value. In addition, as discussed below, the instructions 615 may implement a feature function to determine an updated auxiliary loss. In some examples, the instructions 615 may enable a “back-and-forth” process optimize for auxiliary loss.

In this manner, in some examples, upon optimizing with respect to auxiliary loss, the instructions 616 may enable utilization of enhanced relationship and interaction information captured via an auxiliary loss to implement an inference stage to generate a prediction associated with a user and a content item. In some examples, to generate the prediction, a dot product function may be utilized to calculate a dot product of the user embedding and the content item embedding. In one example, the prediction may indicate a likelihood that a user may select a content item and may be utilized to improve performance in click-through rate (CTR) predictions and recommendations. In addition, in some examples, the instructions 616 may implement a prediction loss function to determine a prediction loss in order to quantify accuracy of a predicted association between the content item and the user.

Moreover, in some examples, the instructions 617 utilize a determined likelihood to provide a recommendation associated with a user. In some examples, the instructions 617 may determine similar likelihoods (i.e., predictions) for each content item in a library of content items. In some examples, these determined predictions associated with the library of content items may be utilized to rank each of the content items in the library and recommend a content item most likely to be of interest to the user.

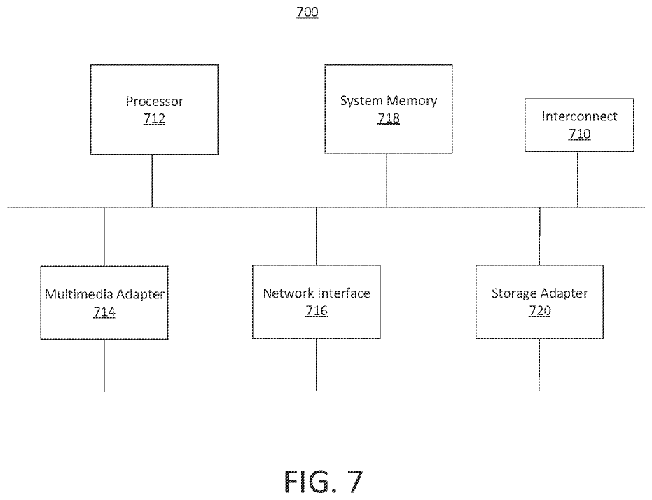

FIG. 7 illustrates a block diagram of a computer system for customized outreach plan generation and optimization based on virtual structures, according to an example. In one example, the computer system 700 may be associated with the system 610 to perform the functions and features described herein. The computer system 700 may include, among other things, an interconnect 710, a processor 712, a multimedia adapter 714, a network interface 716, a system memory 718, and a storage adapter 720.

The interconnect 710 may interconnect various subsystems, elements, and/or components of the computer system 700. As shown, the interconnect 710 may be an abstraction that may represent any one or more separate physical buses, point-to-point connections, or both, connected by appropriate bridges, adapters, or controllers. In some examples, the interconnect 710 may include a system bus, a peripheral component interconnect (PCI) bus or PCI-Express bus, a HyperTransport or industry standard architecture (ISA)) bus, a small computer system interface (SCSI) bus, a universal serial bus (USB), IIC (I2C) bus, or an Institute of Electrical and Electronics Engineers (IEEE) standard 1394 bus, or “firewire,” or other similar interconnection element.

In some examples, the interconnect 710 may allow data communication between the processor 712 and system memory 718, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 712 may be the central processing unit (CPU) of the computing device and may control overall operation of the computing device. In some examples, the processor 712 may accomplish this by executing software or firmware stored in system memory 718 or other data via the storage adapter 720. The processor 712 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 714 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 716 may provide the computing device with an ability to communicate with a variety of remote devices over a network (e.g., the network 640 of FIG. 6A) and may include, for example, an Ethernet adapter, a Fibre Channel adapter, and/or other wired- or wireless-enabled adapter. The network interface 716 may provide a direct or indirect connection from one network element to another, and facilitate communication and between various network elements.

The storage adapter 720 may connect to a standard computer-readable medium for storage and/or retrieval of information, such as a fixed disk drive (internal or external).

Many other devices, components, elements, or subsystems (not shown) may be connected in a similar manner to the interconnect 710 or via a network (e.g., network 640 of FIG. 6A). Conversely, all of the devices shown in FIG. 7 need not be present to practice the present disclosure. The devices and subsystems can be interconnected in different ways from that shown in FIG. 7. Code to implement the dynamic approaches for payment gateway selection and payment transaction processing of the present disclosure may be stored in computer-readable storage media such as one or more of system memory 718 or other storage. Code to implement the dynamic approaches for payment gateway selection and payment transaction processing of the present disclosure may also be received via one or more interfaces and stored in memory. The operating system provided on the computer system 700 may be MS-DOS, MS-WINDOWS, OS/2, OS X, IOS, ANDROID, UNIX, Linux, or another operating system.

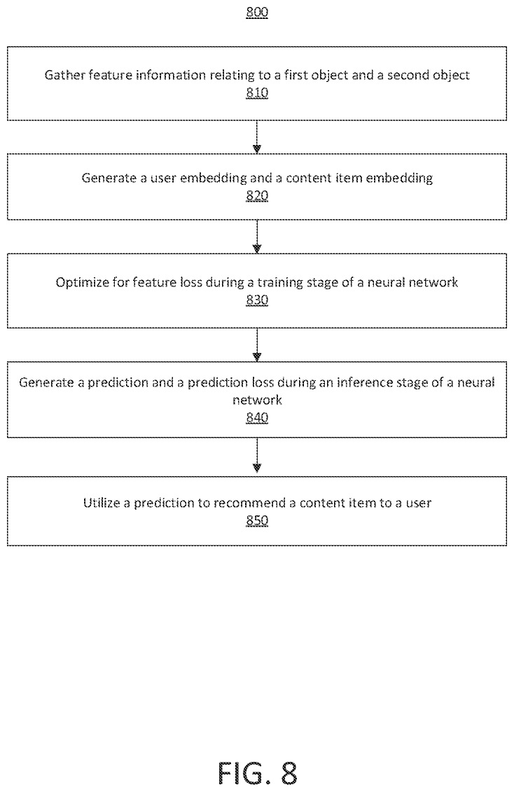

FIG. 8 illustrates a flow diagram of a method that may be implemented to enable auxiliary loss determinations to optimize inference performance of neural networks, according to an example. The method 800 is provided by way of example, as there may be a variety of ways to carry out the method described herein. Each block shown in FIG. 8 may further represent one or more processes, methods, or subroutines, and one or more of the blocks may include machine-readable instructions stored on a non-transitory computer-readable medium and executed by a processor or other type of processing circuit to perform one or more operations described herein.

Although the method 800 is primarily described as being performed by system 610 as shown in FIGS. 6A-B, the method 800 may be executed or otherwise performed by other systems, or a combination of systems. It should be appreciated that, in some examples, to employ neural network (NN) architecture to generate and optimize learnings from embeddings, the method 800 may be configured to incorporate artificial intelligence or deep learning techniques, as described above. Furthermore, in some cases, it should be appreciated that any information associated with the method 800 may be iteratively simulated, in that the information may be returned for further simulation based on a dynamic processing. In some examples, the method 800 may be implemented to aid in recommendation of the content item for the user. However, it should be appreciated that the method 800 may be applied other contexts as well, such as machine vision, natural language processing, social networks and bioinformatics.

At 810, the processor 611 may implement a first input function to gather input data relating to feature information associated with a user (i.e., a first object) and a content item (i.e., a second object). In some examples, the gathered feature information may include one or more of sparse features associated with the user, dense features associated with the user, sparse features associated with the content item and dense features associated with the content item.

At 820, the processor 611 may be employed in association with a neural network (NN) to generate a user embedding and a content item embedding. As discussed above, the user embedding and the content item embedding may be used to provide embedding-level feature information for analysis.

At 830, the processor 611 may be employed in association with a neural network (NN) to optimize a neural network for auxiliary loss. In some examples, the generation of the initial feature value and the initial auxiliary loss may be part of a forward propagation phase of a training stage for the neural network. That is, in some examples, the processor 611 may provide the embedding-level feature information provided by the user embedding and the content item embedding to a multi-layer perceptron (MLP) to generate an initial feature value. In addition, in some examples, the instructions 615 may also implement a feature function to determine an initial auxiliary loss, which may be used to implicitly transmit the enhanced relationship and interaction information during an inference stage of the neural network.

In addition, at 830, the processor 611 may be employed in association with a neural network (NN) to implement a backpropagation phase of a training stage. In some examples, the instructions may enable the initial auxiliary loss to be “backpropagated” (i.e., returned) to enable (re)generation of a user embedding and a content item embedding. Also, in some examples, to backpropagate the initial auxiliary loss, the (re)generated user embedding and the (re)generated content item embedding may be provided to the multi-layer perceptron (MLP) to determine an updated feature value. In addition, the processor may enable the neural network to implement a feature function to determine an updated auxiliary loss.

At 840, the processor 611 may be employed in association with the neural network (NN), to implement an inference stage. In some examples, upon optimizing with respect to auxiliary loss, the processor 611 may enable generation of a prediction and a prediction loss associated with a user and a content item. In some examples, to enable generation a prediction associated with a user and a content item, the processor 601 may utilize a dot product function to calculate a dot product of the user embedding and the content item embedding, wherein the dot product may indicate a likelihood (i.e., a prediction) that a user may select a content item. In addition, in some examples, the processor 611 may implement a prediction loss function to determine a prediction loss to quantify how accurately the neural network may predict an association between the content item and the user.

Furthermore, at 850, the processor 611 may be employed in association with the neural network (NN) to utilize a generated prediction to recommend a content item to a user. That is, in some examples, the processor 611 may enable determination of similar likelihoods (i.e., predictions) for other content items in a library of content items. These predictions may be utilized to rank each of the content items in the library, and to recommend a content item most likely to be of interest to the user.

By utilizing artificial intelligence (AI) based techniques and mechanisms to utilizing neural network (NN) architecture to incorporate generation and implementation of an auxiliary loss component, the systems and methods described herein may utilize to capture representative feature information that may provide enhanced representations of relationships and interactions between a first object and a second object. The systems and methods may also improve representations provided by a first embedding for a first object (e.g., a user) and a second embedding for a second object (e.g., a content item), and effectively capture one or more associated relationships and interactions. These one or more relationships and interactions may be indicative of how likely the first object will be “interested” (i.e., affiliated) in the second object. Accordingly, the system and methods may overcome constraints in computational times and ameliorate burdens on system resources by utilizing implementing optimizing neural network structures to effectively ascertain relationships between one or more first object and one or more second objects.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, autonomous driving, bioinformatics, image processing and recognition and/or other types of knowledge or data-driven systems.

It should be noted that the functionality described herein may be subject to one or more privacy policies, described below, enforced by the system 610, the external system 620, and the client devices 630A-B that may bar use of images for concept detection, recommendation, generation, and analysis.

In particular examples, one or more objects of a computing system may be associated with one or more privacy settings. The one or more objects may be stored on or otherwise associated with any suitable computing system or application, such as, for example, the system 610, the external system 620, and the client devices 630A-B, a social-networking application, a messaging application, a photo-sharing application, or any other suitable computing system or application. Although the examples discussed herein may be in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular examples, privacy settings for an object may specify a “blocked list” of users or other entities that should not be allowed to access certain information associated with the object. In particular examples, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular examples, privacy settings may allow users to opt in to or opt out of having their content, information, or actions stored/logged by the system 610, the external system 620, and the client devices 630A-B, or shared with other systems. Although this disclosure describes using particular privacy settings in a particular manner, this disclosure contemplates using any suitable privacy settings in any suitable manner.

In particular examples, the system 610, the external system 620, and the client devices 630A-B may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular examples, the system 610, the external system 620, and the client devices 630A-B may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular examples, different privacy settings may be provided for different user groups or user demographics. As an example and not by way of limitation, a first user may specify that other users who attend the same university as the first user may view the first user's pictures, but that other users who are family members of the first user may not view those same pictures.

In particular examples, the system 610, the external system 620, and the client devices 630A-B may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular examples, privacy settings may allow a first user to specify (e.g., by opting out, by not opting in) whether the system 610, the external system 620, and the client devices 630A-B may receive, collect, log, or store particular objects or information associated with the user for any purpose. In particular examples, privacy settings may allow the first user to specify whether particular applications or processes may access, store, or use particular objects or information associated with the user. The privacy settings may allow the first user to opt in or opt out of having objects or information accessed, stored, or used by specific applications or processes. The system 610, the external system 620, and the client devices 630A-B may access such information in order to provide a particular function or service to the first user, without the system 610, the external system 620, and the client devices 630A-B having access to that information for any other purposes. Before accessing, storing, or using such objects or information, the system 610, the external system 620, and the client devices 630A-B may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the system 610, the external system 620, and the client devices 630.

In particular examples, a user may specify whether particular types of objects or information associated with the first user may be accessed, stored, or used by the system 610, the external system 620, and the client devices 630. As an example and not by way of limitation, the first user may specify that images sent by the first user through the system 610, the external system 620, and the client devices 630A-B may not be stored by the system 610, the external system 620, and the client devices 630. As another example and not by way of limitation, a first user may specify that messages sent from the first user to a particular second user may not be stored by the system 610, the external system 620, and the client devices 630. As yet another example and not by way of limitation, a first user may specify that all objects sent via a particular application may be saved by the system 610, the external system 620, and the client devices 630.

In particular examples, privacy settings may allow a first user to specify whether particular objects or information associated with the first user may be accessed from the system 610, the external system 620, and the client devices 630. The privacy settings may allow the first user to opt in or opt out of having objects or information accessed from a particular device (e.g., the phone book on a user's smart phone), from a particular application (e.g., a messaging app), or from a particular system (e.g., an email server). The system 610, the external system 620, and the client devices 630A-B may provide default privacy settings with respect to each device, system, or application, and/or the first user may be prompted to specify a particular privacy setting for each context. As an example and not by way of limitation, the first user may utilize a location-services feature of the system 610, the external system 620, and the client devices 630A-B to provide recommendations for restaurants or other places in proximity to the user. The first user's default privacy settings may specify that the system 610, the external system 620, and the client devices 630A-B may use location information provided from one of the client devices 630A-B of the first user to provide the location-based services, but that the system 610, the external system 620, and the client devices 630A-B may not store the location information of the first user or provide it to any external system. The first user may then update the privacy settings to allow location information to be used by a third-party image-sharing application in order to geo-tag photos.

In particular examples, privacy settings may allow a user to specify whether current, past, or projected mood, emotion, or sentiment information associated with the user may be determined, and whether particular applications or processes may access, store, or use such information. The privacy settings may allow users to opt in or opt out of having mood, emotion, or sentiment information accessed, stored, or used by specific applications or processes. The system 610, the external system 620, and the client devices 630A-B may predict or determine a mood, emotion, or sentiment associated with a user based on, for example, inputs provided by the user and interactions with particular objects, such as pages or content viewed by the user, posts or other content uploaded by the user, and interactions with other content of the online social network. In particular examples, the system 610, the external system 620, and the client devices 630A-B may use a user's previous activities and calculated moods, emotions, or sentiments to determine a present mood, emotion, or sentiment. A user who wishes to enable this functionality may indicate in their privacy settings that they opt into the system 610, the external system 620, and the client devices 630A-B receiving the inputs necessary to determine the mood, emotion, or sentiment. As an example and not by way of limitation, the system 610, the external system 620, and the client devices 630A-B may determine that a default privacy setting is to not receive any information necessary for determining mood, emotion, or sentiment until there is an express indication from a user that the system 610, the external system 620, and the client devices 630A-B may do so. By contrast, if a user does not opt into the system 610, the external system 620, and the client devices 630A-B receiving these inputs (or affirmatively opts out of the system 610, the external system 620, and the client devices 630A-B receiving these inputs), the system 610, the external system 620, and the client devices 630A-B may be prevented from receiving, collecting, logging, or storing these inputs or any information associated with these inputs. In particular examples, the system 610, the external system 620, and the client devices 630A-B may use the predicted mood, emotion, or sentiment to provide recommendations or advertisements to the user. In particular examples, if a user desires to make use of this function for specific purposes or applications, additional privacy settings may be specified by the user to opt in to using the mood, emotion, or sentiment information for the specific purposes or applications. As an example and not by way of limitation, the system 610, the external system 620, and the client devices 630A-B may use the user's mood, emotion, or sentiment to provide newsfeed items, pages, friends, or advertisements to a user. The user may specify in their privacy settings that the system 610, the external system 620, and the client devices 630A-B may determine the user's mood, emotion, or sentiment. The user may then be asked to provide additional privacy settings to indicate the purposes for which the user's mood, emotion, or sentiment may be used. The user may indicate that the system 610, the external system 620, and the client devices 630A-B may use his or her mood, emotion, or sentiment to provide newsfeed content and recommend pages, but not for recommending friends or advertisements. The system 610, the external system 620, and the client devices 630A-B may then only provide newsfeed content or pages based on user mood, emotion, or sentiment, and may not use that information for any other purpose, even if not expressly prohibited by the privacy settings.

In particular examples, privacy settings may allow a user to engage in the ephemeral sharing of objects on the online social network. Ephemeral sharing refers to the sharing of objects (e.g., posts, photos) or information for a finite period of time. Access or denial of access to the objects or information may be specified by time or date. As an example and not by way of limitation, a user may specify that a particular image uploaded by the user is visible to the user's friends for the next week, after which time the image may no longer be accessible to other users. As another example and not by way of limitation, a company may post content related to a product release ahead of the official launch and specify that the content may not be visible to other users until after the product launch.

In particular examples, for particular objects or information having privacy settings specifying that they are ephemeral, the system 610, the external system 620, and the client devices 630A-B may be restricted in its access, storage, or use of the objects or information. The system 610, the external system 620, and the client devices 630A-B may temporarily access, store, or use these particular objects or information in order to facilitate particular actions of a user associated with the objects or information, and may subsequently delete the objects or information, as specified by the respective privacy settings. As an example and not by way of limitation, a first user may transmit a message to a second user, and the system 610, the external system 620, and the client devices 630A-B may temporarily store the message in a content data store until the second user has viewed or downloaded the message, at which point the system 610, the external system 620, and the client devices 630A-B may delete the message from the data store. As another example and not by way of limitation, continuing with the prior example, the message may be stored for a specified period of time (e.g., 2 weeks), after which point the system 610, the external system 620, and the client devices 630A-B may delete the message from the content data store.

In particular examples, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular examples, the system 610, the external system 620, and the client devices 630A-B may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the system 610, the external system 620, and the client devices 630. The user's privacy settings may specify that such information may be used only for particular processes, such as authentication, and further specify that such information may not be shared with any external system or used for other processes or applications associated with the system 610, the external system 620, and the client devices 630. As another example and not by way of limitation, the system 610, the external system 620, and the client devices 630A-B may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any external system or used by other processes or applications associated with the system 610, the external system 620, and the client devices 630. As another example and not by way of limitation, the system 610, the external system 620, and the client devices 630A-B may provide a functionality for a user to provide a reference image (e.g., a facial profile, a retinal scan) to the online social network. The online social network may compare the reference image against a later-received image input (e.g., to authenticate the user, to tag the user in photos). The user's privacy setting may specify that such voice recording may be used only for a limited purpose (e.g., authentication, tagging the user in photos), and further specify that such voice recording may not be shared with any external system or used by other processes or applications associated with the system 610, the external system 620, and the client devices 630.

In particular examples, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. The system 610, the external system 620, and the client devices 630A-B may determine that this privacy setting also applies to the first image and make the first image visible only to the first user group. In particular examples, the change in privacy settings may take effect only going forward. Continuing the example above, if the first user changes privacy settings and then shares a second image, the second image may be visible only to the first user group, but the first image may remain visible to all users. In particular examples, in response to a user action to change a privacy setting, the system 610, the external system 620, and the client devices 630A-B may further prompt the user to indicate whether the user wants to apply the changes to the privacy setting retroactively. In particular examples, a user change to privacy settings may be a one-off change specific to one object. In particular examples, a user change to privacy may be a global change for all objects associated with the user.

In particular examples, the system 610, the external system 620, and the client devices 630A-B may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In particular examples, upon determining that a trigger action has occurred, the system 610, the external system 620, and the client devices 630A-B may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular examples, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (i.e., “public”). However, if the user changes his or her relationship status, the system 610, the external system 620, and the client devices 630A-B may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the system 610, the external system 620, and the client devices 630A-B may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular examples, a user may need to provide verification of a privacy setting on a periodic basis. A prompt or reminder may be periodically sent to the user based either on time elapsed or a number of user actions. As an example and not by way of limitation, the system 610, the external system 620, and the client devices 630A-B may send a reminder to the user to confirm his or her privacy settings every six months or after every ten photo posts. In particular examples, privacy settings may also allow users to control access to the objects or information on a per-request basis. As an example and not by way of limitation, the system 610, the external system 620, and the client devices 630A-B may notify the user whenever an external system attempts to access information associated with the user and require the user to provide verification that access should be allowed before proceeding.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

1. A system for implementing a feature-based technique for inference performance in a neural network, comprising:
a processor;
a memory storing instructions, which when executed by the processor, cause the processor to:
receive first input data relating to a first object and second input data relating to a second object;
generate a first embedding associated with the first object utilizing the first input data and a second embedding associated with the second object utilizing the second input data;
training, using a machine-learning technique, the neural network during a training stage by:
determining enhanced relationship and interaction information associated with the first object and the second object and an initial feature value utilizing the first embedding and the second embedding;
generating a modified first embedding and a modified second embedding utilizing the enhanced relationship and interaction information and the initial feature value; and
determining an updated feature value utilizing the modified first embedding and the modified second embedding; and
generate, during an inference stage of the neural network, by utilizing the modified first embedding and the modified second embedding, a prediction associated with the first object and the second object.

2. The system of claim 1, wherein the first object is a user and the second object is a content item.

3. The system of claim 1, wherein the initial feature value is generated utilizing forward propagation.

4. The system of claim 1, wherein the updated feature value is generated utilizing backpropagation.

5. The system of claim 1, wherein the enhanced relationship and interaction information is determined utilizing a multi-layer perceptron (MLP).

6. The system of claim 5, wherein the multi-layer perceptron (MLP) is offline during the inference stage.

7. The system of claim 1, wherein the instructions when executed by the processor further cause the processor to determine a prediction loss.

8. A method for implementing dedicated feature-based techniques to optimize inference performance in a neural network, comprising:
generating a first embedding for a first object and a second embedding for a second object;
determining enhanced relationship and interaction information associated with the first object and the second object and an initial feature value utilizing the first embedding and the second embedding;
generating a modified first embedding and a modified second embedding utilizing the enhanced relationship and interaction information and the initial feature value;
determining an updated feature value utilizing the modified first embedding and the modified second embedding; and
generating a prediction and a prediction loss associated with the first object and the second object utilizing the modified first embedding and the modified second embedding.

9. The method of claim 8, wherein the first object is a user and the second object is a content item.

10. The method of claim 8, further comprising implementing a training stage of the neural network, the training stage including the determining the enhanced relationship and interaction information and the initial feature value, the generating the modified first embedding and the modified second embedding and the determining the updated feature value.

11. The method of claim 8, further comprising implementing an inference stage of the neural network, the inference stage including the generating the prediction and the prediction loss.

12. The method of claim 8, wherein the initial feature value is determined utilizing forward propagation.

13. The method of claim 8, wherein the updated feature value is determined utilizing backpropagation.

14. The method of claim 8, wherein the prediction is used to determine a click-through rate (CTR) prediction.

15. A non-transitory computer-readable storage medium for optimizing inference performance in a neural network and having an executable stored thereon, which to when executed instructs a processor to:
determine, utilizing a first embedding associated with a first object and a second embedding associated with a second object, enhanced relationship and interaction information associated with the first object and the second object and an initial feature value;
generate, utilizing the initial feature value, a modified first embedding and a modified second embedding;
determine an updated feature value utilizing the modified first embedding and the modified second embedding; and
generate a prediction and a prediction loss associated with the first object and the second object utilizing the modified first embedding and the modified second embedding.

16. The non-transitory computer-readable storage medium of claim 15, wherein the first object is a user and the second object is a content item.

17. The non-transitory computer-readable storage medium of claim 15, wherein the first object is a user and the second object is an item to be sold.

18. The non-transitory computer-readable storage medium of claim 15, wherein the first object is an road object and the second object is an action to be taken by a vehicle.

19. The non-transitory computer-readable storage medium of claim 18, wherein the enhanced relationship and interaction information is determined utilizing a multi-layer perceptron (MLP).

20. The non-transitory computer-readable storage medium of claim 15, wherein the updated feature value is determined utilizing backpropagation.
